(19) United States
(12) Patent Application Publication
(10) Pub. No.: US 2009/0056281 A1
(43) Pub. Date: Mar. 5, 2009

(54) Shaped Flexible Pouch With Elongated Neck And Method Of Manufacture

(75) Inventor: R. Charles Murray, Lakewood Ranch, FL (US)

Correspondence Address: GIFFORD, KRASS, SPRINKLE,ANDERSON & CITKOWSKI, P.C, PO BOX 7021, TROY, MI, 48007-7021, US

(73) Assignee: Pouch Pac Innovations, LLC, Sarasota, FL (US)

(21) Appl. No.: 12/199,261

(22) Filed: Aug. 27, 2008

Related U.S. Application Data
(60) Provisional application No. 60/968,181, filed on Aug. 27, 2007.

(51) Int. Cl. B65B 43/04; B65D 33/00; B31B 49/00

(52) U.S. Cl. 53/455; 383/200; 493/267

(57) ABSTRACT

Accordingly, the present invention is an improved flexible pouch for a product and an improved apparatus and method for manufacturing the pouch. The flexible pouch, apparatus and methodology for a pouch includes an upper edge and side edges extending therefrom. The upper edge includes an elongated spout portion extending therefrom. The elongated spout portion can have shape representative of a bottle cap attached to a top of bottle throat. In addition, the elongated spout portion can have an opening element that affords for tearing off the bottle cap shaped portion and allow access to the product.

### CROSS-REFERENCE TO RELATED APPLICATIONS

This application claims priority of U.S. Provisional Patent Application Ser. No. 60/968,181 filed Aug. 27, 2007, which is incorporated herein by reference.

### FIELD OF THE INVENTION

The present invention relates generally to a flexible pouch for packaging a product and, more specifically, to a shaped flexible pouch with an elongated neck for packaging a product and an apparatus and method of manufacturing the same.

### BACKGROUND OF THE INVENTION

Various types of disposable, portable containers are known in the art for storing a fluid or dry product, such as a liquid, granular material, powder or the like. One example of such a container is a flexible pouch. Consumers prefer the convenience of flexible pouches, due to their shape, size, shelf life and storage adaptability. Manufacturers recognize the packaging benefits of a flexible pouch, since the pouch can be formed and filled on the same manufacturing line. An example of a method and apparatus for filling a flexible pouch with a product is disclosed in commonly assigned U.S. Pat. No. 6,199,601, which is incorporated herein by reference.

The flexible pouch is made from a flexible material, such as an extrusion or a laminate composed of sheets of plastic or aluminum or the like. An outer layer of the material may have preprinted information, such as a logo or the like, to provide the consumer with information regarding the contents of the pouch. The material is available in sheet form, on a roll, and a plurality of pouches may be fabricated from one width of the roll.

The pouch may be formed using conventionally known manufacturing techniques, such as a horizontal form-fill-seal machine with single or multiple lanes, a flat bed pre-made pouch machine, a vertical form-fill-seal machine, or the like. The machine includes a number of stations, with a particular operation or operations taking place at each station. The pouch is generally formed by folding a sheet or sheets of material over each other to achieve a predetermined shape. The pouch may also include an insert or gusset positioned between two parallel edges to form a pouch capable of standing unsupported. Edges, such as a side edge, may be joined together using a sealing technique such as bonding or welding. Alternatively, the roll is folded to form a pouch with three open sides. An upper edge of the front panel and back panel is generally not sealed until after the pouch is filled. The empty pouch may be placed in a corner, or gripper assembly or a holder such as a cup or puck or combination of both prior to the filling process. The pouch is ready to be filled, sealed and finished as required.

The integrity of the closing seal is an important functional feature of the pouch, and a poor seal can lead to a failure of the seam. In addition, the ease of removing the product from the pouch is another important feature. Thus, there is a need in the art for a flexible pouch having an elongated spout and an improved seal and an apparatus and method of making such a flexible pouch.

### SUMMARY OF THE INVENTION

Accordingly, the present invention is an improved flexible pouch for a product and an improved apparatus and method for manufacturing the pouch. The flexible pouch, apparatus and methodology for a pouch includes an upper edge and side edges extending therefrom. The upper edge also includes an elongated spout portion extending therefrom. A side seam, also known as a side seal, extends along the side edges and a predetermined length of the upper edge. A closing seam can overlap a predetermined length of the side seam extending along the upper edge.

The method can include the steps of unrolling a sheet material along a horizontal orientation and checking the alignment of the sheet of material and/or adjust the alignment in order to align outer edges of the sheet of material. Thereafter the sheet of material can be cut into sections the aligned sections positioned to form a body of the pouch. A rib can be formed in the elongated spout portion, the individual pouches separated from the roll width of material and the pouches removed from the machine.

Other features and advantages of the present invention will be readily appreciated, as the same becomes better understood after reading the subsequent description taken in conjunction with the accompanying drawings.

### BRIEF DESCRIPTION OF THE DRAWINGS

FIG. 1 is a partial cross-sectional side view of a flexible pouch with an elongated spout according to an embodiment of the present invention;

FIG. 2 is a partial cross-sectional side view of a flexible pouch with an elongated spout according to another embodiment of the present invention;

FIG. 3 is a partial cross-sectional side view of a flexible pouch with an elongated spout according to another embodiment of the present invention;

FIG. 4 is a partial cross-sectional side view of a flexible pouch with an elongated spout according to another embodiment of the present invention;

FIG. 5 is a side view of a flexible pouch with a spout fitment according to another embodiment of the present invention;

FIG. 6 is a side view of a flexible pouch with a threaded spout fitment and a cap according to another embodiment of the present invention;

FIG. 7 is a side view of a large capacity shaped pouch with a spout fitment according to another embodiment of the present invention;

FIG. 8 is a side view of a flexible pouch with an integral valve according to another embodiment of the present invention;

FIG. 9 is a flowchart of a method of forming and filling the flexible pouch of FIGS. 1-8 according to an embodiment of the present invention; and

FIG. 10 is a perspective view of an apparatus for manufacturing the flexible pouch of FIGS. 1-8 using the method of FIG. 9 according to an embodiment of the present invention.

### DETAILED DESCRIPTION OF THE PREFERRED EMBODIMENTS

The present invention discloses a flexible container for packaging a product. As such, the flexible container has utility as a container.

The flexible container can include a flexible pouch having an elongated spout portion extending therefrom, and an opening element located at least partially within the elongated spout portion. The opening element is operable to create an opening across the elongated spout portion so that a product that is contained within the flexible pouch can be removed. In some instances, the elongated spout portion has the shape of a bottle cap that is attached to a top of a bottle throat. In some instances, the opening element can be a notch that is located at least partially within the elongated spout portion and can be located in at least one of a pair of side edges that are present. In other instances, the opening element can be a fitment extending from the elongated spout portion, the fitment operable to be opened and/or closed.

The flexible pouch can have a front panel and a back panel, the front panel and back panel each having an upper edge and a pair of side edges extending therefrom. It is appreciated that for the purposes of the present invention, the term “panel” is equivalent to the term “wall” and may be used interchangeably. The elongated spout portion can extend from the upper edge of each panel in a direction generally away from the pair of side edges. A side seam joins at least one of the pair of side edges of the front panel to at least one of the pair of side edges of the back panel. The side seam can also extend to and join a predetermined distance of the upper edge of the front panel to the upper edge of the back panel. A closing seam can overlap the side seam and join at least part of the upper edge and at least part of the elongated spout portion of the front panel to at least part of the upper edge and at least part of the elongated spout portion of the back panel, and in so doing afford for a flexible pouch with a product contained therein.

Referring to FIG. 1, a container is shown generally at reference numeral 10. The container 10 includes a flexible pouch 100 that can be filled with a product (not shown) and sealed. The filled pouch may assume various shapes, such as cylindrical, cube, conical or the like. The type of product and usage of the pouch influences the shape. The type of product is unlimited, and could have a solid or a liquid form. The pouch 100 may form one compartment for the product. Alternatively, the pouch 100 may include multiple discrete compartments. An example of such a pouch is disclosed in commonly assigned U.S. patent application Ser. No. 11/367,613, which is incorporated herein by reference.

The flexible pouch 100 is preferably formed from a roll of flexible, preprinted laminate material. The choice of laminate material is nonlimiting, and is influenced by factors such as the product contained in the pouch 100, the shape of the pouch or the anticipated use of the pouch. The laminate can be either a three, four, five or more gauge material, and an outer layer preprinted with an indicia 149. It should be appreciated that a portion of the material may be a clear laminate, in order to view the contents of the pouch. For example, the laminate material may include at least one layer of virgin polyethylene terephthalate (PET) and at least one layer of aluminum foil (AL) and another layer such as EVOH, PET, polyethylene, or polypropylene or nylon or the like. The laminate may also include a metalized foil paper layer laminated to a cast polypropylene layer and another layer of PET, polyethylene or EVOH. It should also be appreciated that there may be a fourth layer of nylon.

Another material example includes a cast polypropylene (CPP) layer, a polyethylene (PET) layer, a foil (AL) layer, a nylon (ONO) layer and another CPP layer. Yet another example of a material structure is the use of nylon, foil, nylon, and cast polypropylene (ONO/AL/ONO/CPP) or CPP/NY/AL/CPP. A further example of a laminate material structure is CPP/AL/ONO/PE. This structure works well when the product has a short shelf life, and the nylon eliminates stretching or cracking of the AL layer.

Advantageously, a pouch 100 made using the cast polypropylene laminate material retains its filled shape even as the product is removed from the pouch 100. It should be appreciated that if a filled carbonated pouch is stored at ambient temperature, the laminate will start to creep after a period of time, such as ten days. The laminate material may include an extrusion layer to contain “creepage” or “stretch” of the film after filling due to carbonation expansion, if the product is carbonated. In addition, the selected material may be organoleptic compliant in order to avoid the transfer of odor contaminants to the product, or product contamination during the shelf life period of the product.

The pouch 100 itself can be defined by a panel, which may be formed using one or more sheets of material. The pouch 100 can include a front panel 112 and a back panel 114, with each of the panels having a pair of oppositely disposed side edges 120. The side edges 120 of the front panel 112 can be aligned with and oppositely disposed from the side edges 120 of the back panel 114, thereby affording for the front panel sides edges to be joined to the back panel side edges with a seal to form a seam 121. In the alternative, one sheet of material can be folded so that outer edges of the one sheet can be joined together to form one seam.

The pouch 100 can also have an upper edge 116 and an opposed lower edge 118 with at least one of the side edges 120 extending between the upper and lower edges 116, 118. The side edge 120 of the pouch 100 may be shaped, such as linear or curvilinear or the like. The upper edge 116 of the pouch can include an elongated spout portion 122. The width ‘W1’ of the elongated spout portion 122 is generally less than the overall width ‘W2’ of the pouch 100.

The edges of the pouch 100 can be sealed using heat or ultrasonics or by a combination of heat and ultrasonics. The pouch sealed edges form a seam. The seam may be a fin-style seam, or a flat seam or the like. One of the seams may include an opening element 128, to be described, at least partially within the panels of the pouch 100. In this embodiment, the upper edge 116 includes a closing seal 152 for sealing the pouch 100. The side edge seam 152 may extend into a predetermined portion of the upper edge 116 of the pouch as shown at 150, and a predetermined portion of the closing seal 152 can overlap the predetermined portion of the side seal 121 to form an overlap seal portion 154. The overlap seal portion 154 is advantageous since it reduces any amount of splash during filling of the pouch 100. In addition, the overlap seal portion 154 provides a gripping surface for holding the pouch 100 during an operation.

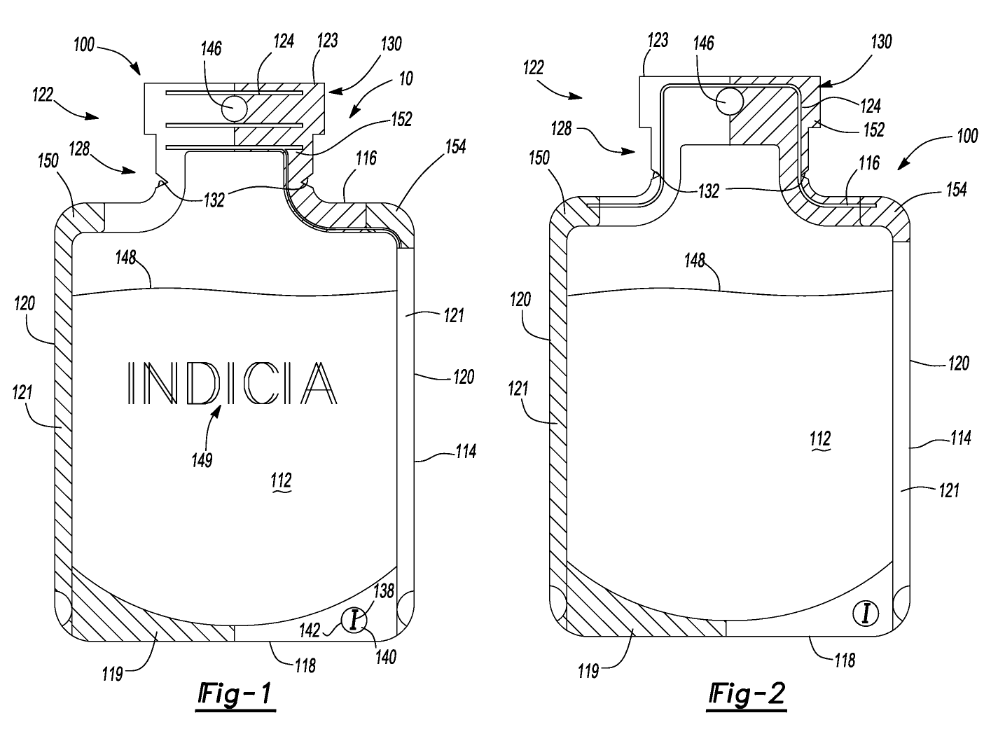

The elongated spout portion 122 may include one or more ribs 124. In an example, the rib 124 extends transversely across the elongated spout portion. There may be more than one rib 124, with each rib spaced a predetermined distance apart. In another embodiment shown in FIG. 2, the rib 124 outlines the shape of the elongated spout. The inclusion of the rib 124 to the elongated spout potion 122 adds rigidity thereto. The rib 124 can prevent and/or reduce curling of the sheet material and thereby improve filling and sealing of the pouch. The rib 124 may be cold-formed in a predetermined shape, such as horizontal or outline. In addition, the rib 124 may be absorbed into the closing seal 152.

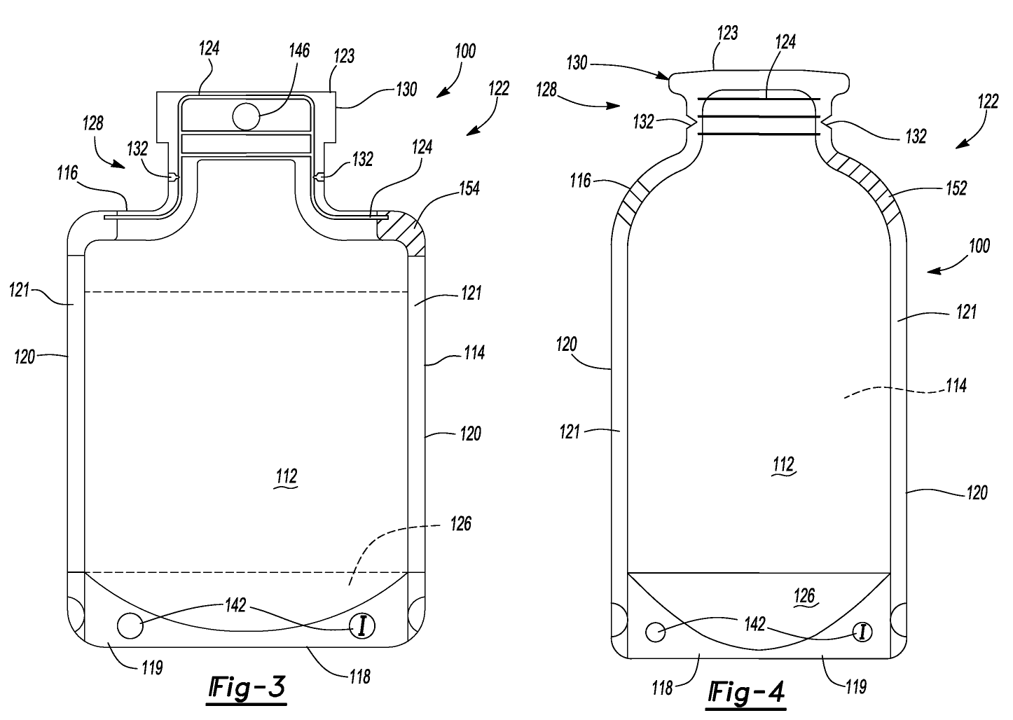

The pouch 100 may include a sidewall 126 as shown in FIGS. 3-4. The sidewall 126 advantageously allows the pouch 100 to acquire another shape, such as cylindrical, or to stand upright. The sidewall 126 may be integrally formed in the front panel 112 and/or back panel 114 as a gusset or a separate piece of material as an insert (not shown). The sidewall 126 may be located between the side edges 120 of the panels, between the upper edges 116 and/or between the lower edges 118. The sidewall 126 may be generally wider at the lower edges 118 and taper upwardly towards the upper edges 116, or be of a uniform dimension. The sidewall 126 may be formed between the lower edges 118 of the pouch 100 to provide a base for the pouch 100 to stand upright. A sidewall 126 formed between the side edges 120 or the upper edges 116 may serve as an area for receiving the opening element 128.

The gusset 126 can have reduced material due to improved alignment of the material and a reduced seal area. The inner surface of the gusset 126 can also have a curvilinear shape, such as parabolic, concave or the like, a rounded shape being advantageous in opening and filling of the pouch 100. It should be appreciated that increased air is required to open the pouch 100, and at a slower production line speed, when the pouch 100 has a wider side seal or gusset seal or edge seal. The pouch 100 can be opened without high pressure or air volume with a narrow seal or a rounded shaped gusset 126.

Various types of opening elements 128 are known in the art for accessing the contents of the pouch 100. It should be appreciated that the opening elements may be added before or after filling the pouch 100 with the product. The pouch 100 may be filled through the elongated spout portion 122 or through an open opposite end before the lower edges 118 are sealed to form a lower seam 119. An example of the opening element 128 is an integral tear notch 132, the notch 132 affording initiating the tearing of a tear-off portion 130. In this example, the tear-off portion 130 is part of the elongated spout portion 122. Another example of an opening element 128 is a straw-pierceable portion for receiving a straw. Yet another example of an opening means is a resealable fitment, such as a zipper that is sold under the name TopTite™. Still a further example of an opening means is a pull tab covering an opening in the pouch.

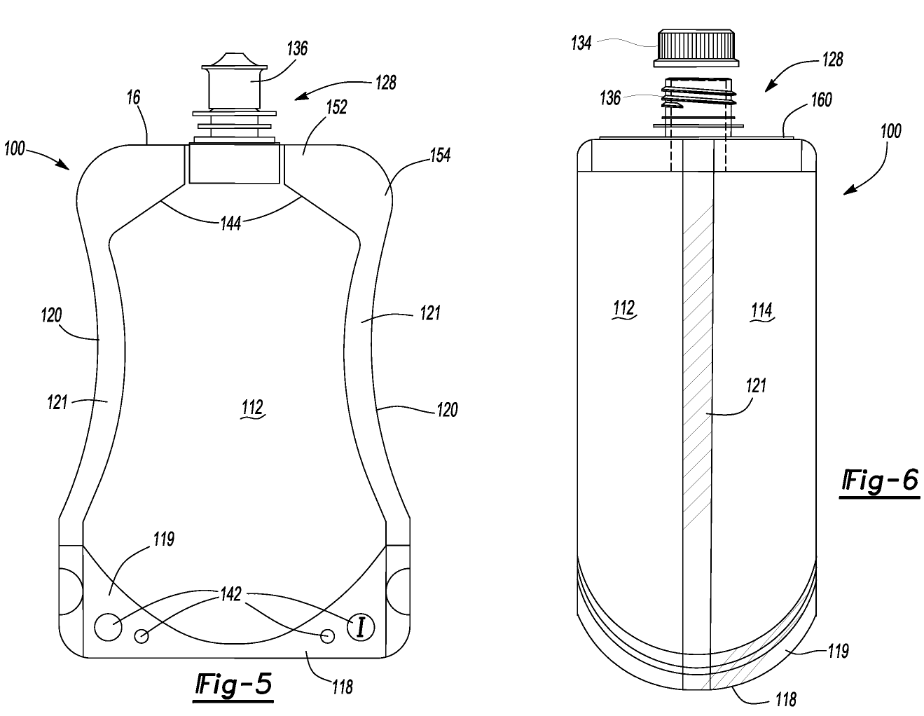

Yet a further example of the opening element 128 for accessing the contents or dispensing the contents from the pouch 100 is a fitment 136 as illustrated in FIG. 5, the fitment 136 affording for opening and/or closing the pouch as is known to those skilled in the art. A threaded fitment 136 with a complimentary cap 134 can also be used as the opening element 128 as illustrated in FIG. 6. The fitment 136 and/or cap 134 can be made from a material such as polypropylene. The spout fitment may have a tamper-evident means. If the product is a carbonated product, the fitment 136 and/or cap 134 may include a carbonation insert and oxygen scavenger to reduce oxygen in the head space. The fitment 136 can be sealed to the pouch 100 between the upper edges 116 of the pouch 100 ultrasonically, by heat sealing or the like.

It should be appreciated that the flexible pouch 100 may advantageously include other features that are known in the art. For example, the pouch may include a tracking device 138 feature integrally located within the pouch 100 that includes electronic tracking information relevant to the pouch 100, as described in commonly assigned U.S. patent application Ser. No. 11/686,666, which is incorporated by reference. In an example, the tracking device 138 may be secured within an airspace or air pocket 140 formed in a sealed portion of the pouch 100 during the manufacturing process. For example, one or more apertures 142 may be punched in the folded area of the gusset 126 to reduce the amount of material in the gusset 126. The tracking device 138 may be inserted in the air pocket 140 formed within one of the gusset apertures 142. The inclusion of the tracking device 138 in the air pocket 140 is advantageous because it improves the signal strength of the tracking device 138.

The tracking device 138 may be an electronic tag, such as a Radio Frequency Identification (RFID) transmitter. The tracking device 138 can store a predetermined amount of electronic information. An example of the information is unique tracking information for a particular pouch 100. For example, the tracking device 138 can provide information about the status of the pouch 100, such as physical location of the pouch 100, age of the pouch 100 or the like. In addition, the tracking device 138 can be utilized for inventory control, delivery, purchase behavior, returns, pricing, and other tracking purposes. The tracking device 138 can be in communication with a receiver (not shown) for reading the information. The receiver may be a computer system having a memory and a processor, a handheld device for receiving an RFID signal, or any other type of device capable of electronic communication with the tracking device 138. The receiver may be a transceiver capable of emitting a radio signal that initiates transmission of information from the tracking device 138. Although the packages are individually read, the RFID tag may be advantageously read at a faster rate than using a barcode in conjunction with a barcode scanner, since the packages are not physically scanned on an individual basis. In addition, the signal from the RFID tag may be advantageously read through an outer layer of material, such as a packaging material, or under various environmental conditions. Another advantage is that the tracking of the physical location of the package may be electronically monitored within a predetermined geographical range.

Alternatively, the tracking device 138 may be inserted in a sealed portion of the pouch, and the air pocket 140 is formed around the tracking device 138 during application of the seal. The tracking device may be integrally formed in the opening means.

The pouch 100 may include a feature such as an angled top seal 144 extending between the side edge 120 and a predetermined location on the upper edge 116 as illustratively shown in FIG. 5. The angled top seal 144 facilitates the removal of product from the pouch 100 by directing the flow of the product towards the opening element 128. An example of such a pouch is disclosed in commonly assigned U.S. patent application Ser. No. 11/683,133 which is incorporated herein by reference.

The pouch 100 may also include a feature such as a hanging aperture 146 located within an edge, such as an upper edge or side edge. The aperture 146 may have various shapes, such as round or curved. The pouch 100 may be supported by a support means, such as a hook member, etc. that extends through the aperture 146. The pouch 100 may be hung for display or storage purposes. The positioning of the hanging aperture 146 above the angled top seal 144 or within a sealed portion prevents the contents of the pouch from leaking out through the aperture 146.

The pouch may include a feature such as a dimple (not shown) for receiving a straw. Another feature is a weakened portion adjacent the opening element, to facilitate opening the pouch. Still another feature is a straw (not shown) attached to the pouch 100. In still another example, the flexible pouch 100 may include a guide pocket (not shown) formed in a wall 112, 114 of the pouch 100 prior to filling and sealing, to facilitate the separation of the front and back walls 112, 114 prior to the filling of the pouch 100. An example of such a pouch is disclosed in commonly assigned U.S. patent application Ser. No. 10/310,221. In a further example, the pouch may contain a body rib that adds strength or support or form to the body of the pouch. The body rib may be thermoformed.

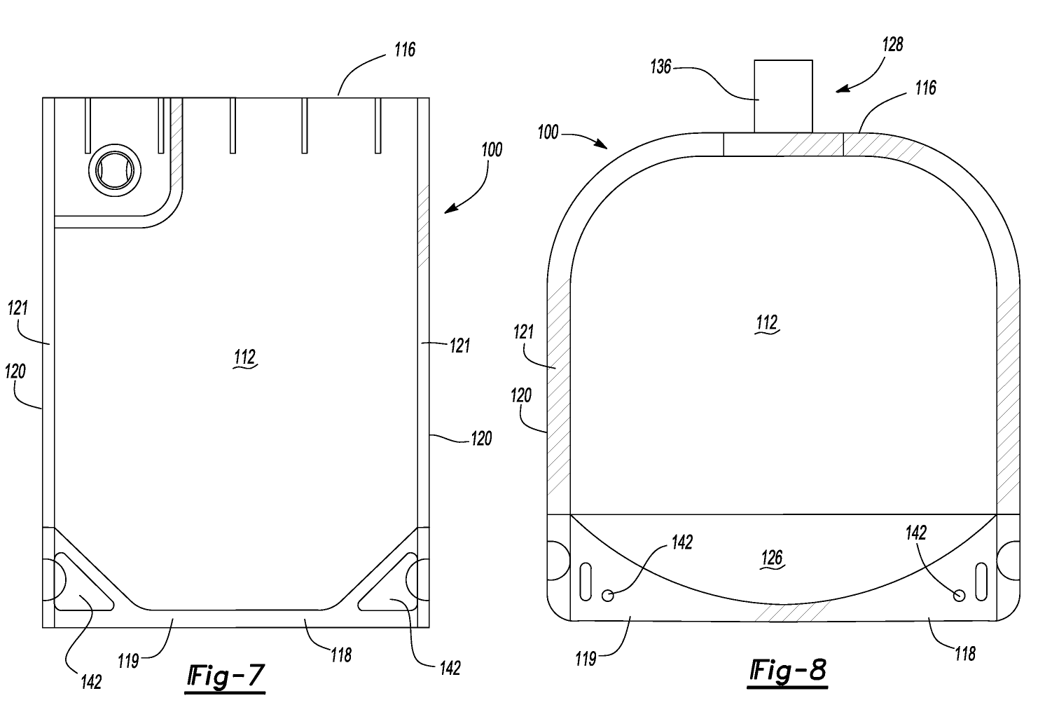

The pouch may include a feature such as an integral vent 129 as shown in FIG. 7. The vent 129, such as a valve, functions to exhaust a gas from the pouch 100. The gas may be formed within the pouch 100 or other reasons, such as gas formed by decaying food or during freezing or the like. The valve 129 remains tightly closed, until pressure from the gas, such as steam, reaches a predetermined pressure value. The valve 129 opens and remains open, to release the gas or stream from the package in a controlled manner. Various types of valves are contemplated. For example, a tape may be used to cover a hole in the front and/or back panel. Alternatively, a pressure relief device, such as that manufactured by PPI Technologies Global, Sarasota, Fla. model number P033F, may be utilized. Another example of a valve is disclosed in commonly assigned U.S. patent application Ser. Nos. 10/228,430 and 10/967,547 and PCT Patent Application No. PCT/US2004/34361.

The pouch may include a feature such as an ergonomic shape. An example of an ergonomically shaped pouch for a carbonated beverage is disclosed in commonly assigned U.S. patent application Ser. No. 11/454,241 which is incorporated by reference. The ergonomic shape may be achieved through carbonation as the pouch 100 is filled with a carbonated product, since the carbonation causes the pressure within the pouch to increase.

The flexible pouch 100 may include a feature such as an outer layer or sleeve 148 covering the outer surface of the pouch. The sleeve may contain the indicia 49, e.g. information about the product, such as a barcode or the like. The sleeve 148 may cover only a portion of the pouch 100 outer surface. Preferably, the sleeve 148 is shrunk over the outer surface of the pouch 100 after the pouch 100 is formed and filled with the product. The sleeve 148 is advantageous because it can cover the side edge seam 121. It also adds one or more layers of material to strengthen the pouch 100 and improve its durability. Various types of material may be utilized for the sleeve, such as paper or plastic including PET or PVC and the choice is non-limiting.

It is contemplated that these are merely examples of features and the flexible pouch 100 may incorporate any of the above-described features or any other feature, in any combination. In addition, the finished pouch may assume various shapes, such as cylindrical, cubical, and conical, hourglass or the like, as influenced by the type of product and intended usage of the pouch. For example and for illustrative purposes only, FIG. 8 shows another embodiment of a flexible pouch 100. It should further be appreciated that the designated upper edge and lower edge is merely for reference purposes.

It is also contemplated that the pouch 100 may undergo a secondary process after it is filled with the product. For example, a filled pouch may be refrigerated, frozen or otherwise modified for an extended shelf life. Alternatively, the filled pouch may be pasteurized for increased shelf life. Examples of pasteurized food products include dairy products such as milk, or meat products such as chicken or the like.

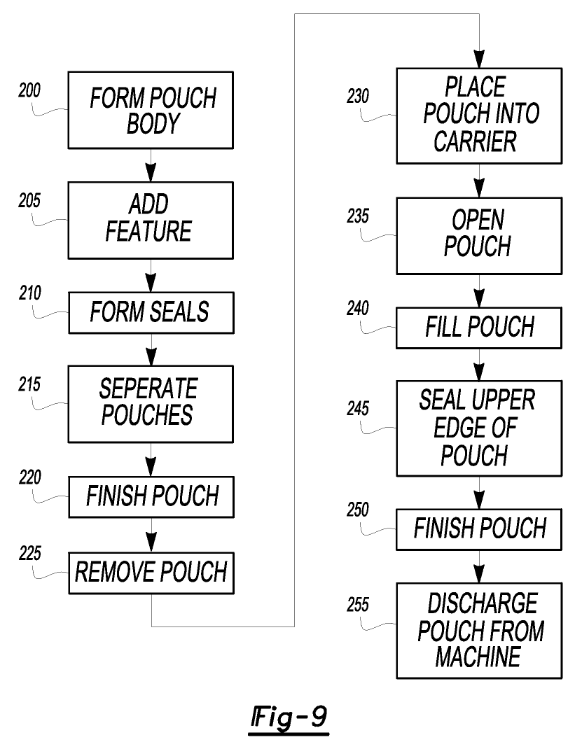

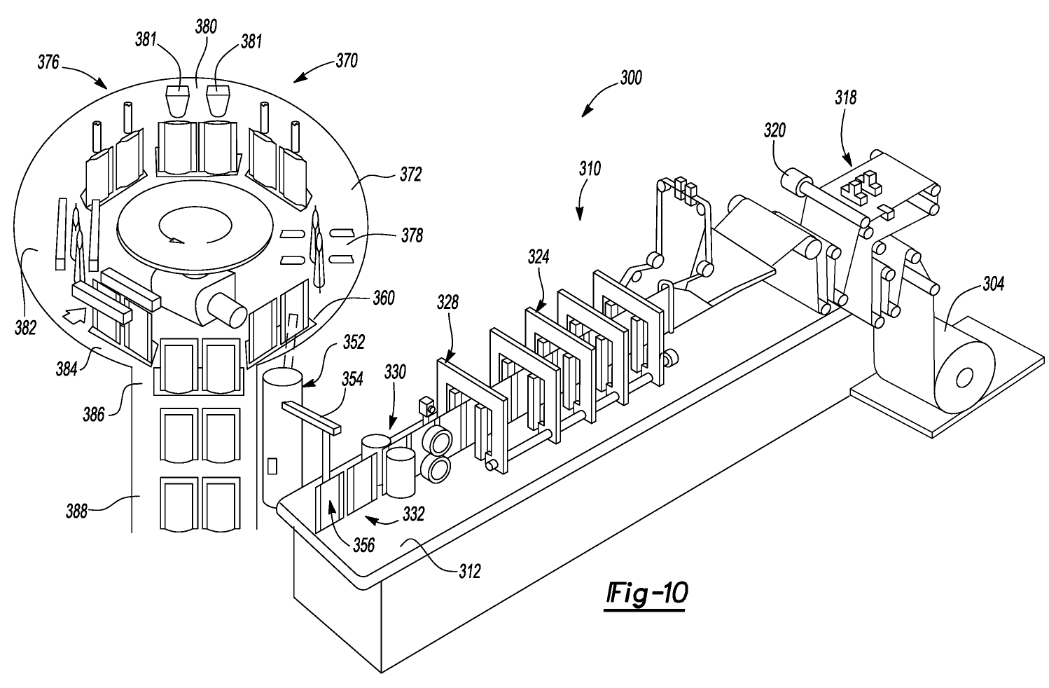

Referring to FIGS. 9-10, a method for forming, filling and/or sealing the flexible pouch 100 using a machine 300 is illustrated. The machine 300 may be a form machine, or a form-fill-seal machine. The method begins in block 200 at a first forming station with the step of preparing a material 304 to form the body of the pouch 100. For example, the material 304 can be a roll of laminate material, as previously described, and can be unrolled along a horizontally oriented plane. The initial width of the roll of material 304 can be determined by the desired finished size of the pouch 100 and the number of pouches obtained from the width. For example, two to four pouches, representing four to eight panels, can be obtained from a width of the roll of material 304 on a two lane machine, three lane machine, four lane or more lane machine, respectively. The film may pass through an ultraviolet light chamber without reflection to remove pathogen and microbiological contaminants. The material 304 can be aligned. Precise alignment of the laminate material 304 is advantageous, especially at a higher machine speed, because the seam tolerance can be more precise and a tighter tolerance reduces the amount of material required to form the pouch 100. An example of an alignment method is disclosed in commonly assigned U.S. patent application Ser. No. 11/674,923, which is incorporated by reference.

For example, to align a material 304, the planar orientation of the unrolling material 304 is changed from a horizontal orientation to a vertical planar orientation as illustrated in FIG. 10. In an example, the machine 300 utilizes an angled roll bar to modify the planar orientation of the unrolling material. The vertical orientation is advantageous in aligning the material 304 prior to cutting. An optical reading means may be utilized, such as an optical scanner or the like to identify a predetermined location of the material, such as an edge of the material or a registration mark.

The determined alignment of the unrolling material 304 may be used to automatically correct the alignment of the unrolling material. In this example, a moveable roller is utilized to adjust the alignment of the material along a vertically oriented axis. For example, the adjustment movement can be ±2 degrees from the vertically oriented axis.

The material 304 may include preprinted information such as labeling information that describes the product contained within the pouch 100. In an example, a layer of preprinted information can be located on an outer layer of the material 304. One layer of the material 304 may also be preprinted with the tracking device 138, such as the RFID transmitter previously described. Alternatively, the RFID transmitter may be secured on the material so that it is located in an air pocket 140 when the pouch 100 is formed at a later step.

The methodology advances to block 205 and a feature is optionally positioned between the unrolling sheets of material. An example of a feature is the vent valve 149 inserted into one of the panels, such as the front panel 112.

Another example of a feature is the gusset 126 inserted between the panels 112, 114. Alternatively, the gusset 126 or a pleat is formed in one of the panels using a folding operation to fold the panel. In one example, the folded pouch has a “V” shape to form the gusset 126. In another example, the folded pouch has a “W” shape. A plurality of apertures 142 may be formed in the gusset 126, such as by using a punch. The plurality of apertures 142 are positioned in the gusseted portion of the material so as to reduce the amount of material in the gusseted portion of the pouch for sealing and/or weight purposes. The tracking device 138 may be advantageously positioned in the air pocket 140 formed by the gusset aperture 142.

In another example of a pouch 100 with one seam, a fold may be formed along an edge in the sheet of material. An example of this type of pouch is disclosed in commonly assigned U.S. patent application Ser. Nos. 11/195,906 and 11/551,075 which are incorporated herein by reference.

A feature such as the opening element 128 may be added in this operation. The opening element 128 may be located on the pouch 100 in a variety of locations, such as bottom, top or side portions of the pouch 100. Various types of opening elements 128 are contemplated, as previously described. For example, an opening element in the form of a straw hole, patch, tear notch and/or spout may be applied. In another example of a reclosable pouch, a zipper, such that manufactured by Zip Tight may be inserted. This type of zipper is easily opened from the outside, however, it provides resistance to pressure on the inside, and the greater the pressure on the inside, the tighter the zipper is sealed. Still another example of a reclosable opening element is an adhesive. Another example is the fitment 136. It should be appreciated that the cap 134 or fitment 136 may have a tracking device embedded therein.

The methodology advances to block 210 and a seal is applied. The edges of the panel can be sealed, such as the side edge 120 or the lower edge 116. In an example of an overlap seal 154, the side seal 150 extends along the side edge 120 of the front panel 112 and the back panel 114 and a predetermined distance along the upper edge 116. Various techniques are known in the art for sealing the edges together. For example, an ultrasonic sealing process may be used. Another technique is a heat weld that includes the application of heat and compression. The seal may be a heat weld process which includes the application of heat and compression in a two-step welding operation.

In another example, the edges of the panels may be sealed using a seal bar. An example of a seal bar is a generally rectangular member conforming to the desired seal shape. The seal bar may include a cavity, such as to create an air pocket. A tracking device 138 may be contained in the air pocket.

An upper edge 123 (FIGS. 1-2) of the elongated spout portion 122 may be left open for filling purposes. Alternatively, all of the edges are sealed and the pouch 100 is filled through the fitment 136. Another seal, such as the angled top seal 144, may also be applied at this time. Advantageously, the seals may be shaped so as to avoid sharp radiuses at the interior corners of the pouch. A rounded interior shape facilitates removal of the product.

In still another example, the edges are sealed using a seal bar or forming plate having a plasma coating. One advantage of the plasma coating is that the line speed may increase. Another advantage is that the coating makes the surface of the seal bar or forming plate more resilient. When the seal bar is heated, the coating expands due to this resiliency. The shear stress on the inner edge of the seal is reduced; resulting in reduced creepage of the material and greater durability of the seal. The plasma coating reduces the opportunity for potential damage to the material during the sealing step. The plasma coating can be a smooth, hard plastic that mimics glass. Since the outer layer of material is not weakened, there is no creepage of the outer layer. Such a seal bar may also include a seal bar recess for forming an air pocket.

In still another example of a sealing technique, the side seal is a two-step seal formed using more than one seal bar. One seal bar may include a seal bar cavity for forming an air pocket in the sealed portion. An example of a two-step seal is disclosed in commonly assigned U.S. patent application Ser. No. 11/551,071. The two-step seal advantageously avoids the generation of ketones due to application of heat to the material. The first or inner seal is a low temperature seal. The second or outer seal is a high temperature seal. The second seal is spaced apart from the first seal by a predetermined distance, to create an air gap. The first seal is a tack seal, such as 6 mm wide, and is of a sufficient temperature so as to melt the layers of material and tack the edges together. The predetermined distance between the first and second seal can be ½-1 mm. The second seal can be applied at a higher temperature and pressure than the first seal. As a result, any gas, such as steam, ketones, aromatics or the like are pushed in an outwardly direction, out through the open edges of the panels, and not into the pouch. Thus, the first seal prevents entry of contaminates into the pouch to avoid organoleptic contamination.

Another technique is a heat weld that includes the application of heat and compression. The heat weld may include a heat weld followed by a cold weld. For example, a seam defining each of the pouches 100 in the roll width of material 304 is formed in aligned first and second unrolling sections of material 304. In this example, the seam is a side section. The lower edge 118 of each pouch 100 may also be sealed at this time. An example of a width of the side seal seam for each individual pouch can be approximately 4±1 mm. It should be appreciated that two side seal seams may be adjoining, and the seal width increased to 8±1 mm. Advantageously, the precise alignment of the roll of material 304 prior to cutting out the sections used to form the pouch panels allows for a decrease in the width of the side seal, and improved pouch opening.

The methodology advances to block 215, and the pouches 10 are separated into individual pouches 10 along a cutting line. For example, each section of material 304 may be first separated along its width, or the side seam of the pouches. The section is then separated into individual pouches 10. In this example, the width of unrolling material 304 represents the side seams. The material is cut into a pouch 100 using a known cutting apparatus, such as a laser, punch or the like. The cutting apparatus forms a single cut in the material to separate the pouches. The size of the pouch 100 is controlled by the distance between the cuts.

In a further example, two consecutive pouches 10 may be separated using a double cutting process, whereby two cuts are made at the same time to separate the upper and lower edges of two pouches at the same time from the sheet of material. Advantageously, forming two pouches during the cutting operation effectively doubles the assembly line speed.

It should be appreciated that the upper edge 116 or lower edge 118 may be further trimmed. For example, the end of the pouch 100 may be trimmed to accommodate a fitment. In another example, two legs are formed during the trimming operation, in order to recess the fitment. In another example, the pouch 100 is trimmed to acquire a predetermined shape.

A feature, such as the opening element 128, may also be applied to the pouch 100 at this time. For example, the spout fitment 136, as previously described, may be sealed within the walls of the pouch 100, such as between the upper edges 116. The spout fitment 136 may be sealed using an ultrasonic seal, a heat weld, or by a combination of ultrasonic seal and heat weld. An example of an ultrasonic seal for a spout fitment is disclosed in commonly assigned U.S. patent application Ser. No. 11/195,906, which is incorporated herein by reference. Accordingly, a base portion of the fitment 136 is sealed between the walls of the pouch 100 using an ultrasonic seal, a heat seal, and then a cool seal. The heat seal melts a layer of the pouch material 304, the material flows around sealing ribs on the base portion and fills in any void between the base portion and the wall of the pouch 100. The cool seal sets the seal and provides an attractive finish to the overall seal. Advantageously, fewer stations are required to seal the spout fitment 136 between the walls of the pouch 100, since a tack seal is eliminated.

In addition, an insert such as gusset 126 may be likewise applied to the pouch 100 at this time. The insert may be positioned at a lower edge of the pouch, an upper edge, or both an upper and lower edge. The methodology advances to block 220.

In block 220, the individual pouches 10 are finished. For example, an outermost edge of the pouch 100 may be trimmed to shape, i.e. the corners may be angled or edges trimmed to accommodate a fitment. The pouch corners may be shaped to have a radius, to eliminate right angles at the corners. The hanging aperture 146, if present, may be formed at this time. This operation may be performed using a cutter, a die cut or the like. In addition, the tear notch 132 may be cut out of an outermost edge of the pouch 100 to facilitate opening of the pouch.

In another example of a finishing operation, a crease or guide pocket may be formed in a top portion of each panel 112, 114 in a creasing operation, in order to facilitate opening and filling of the pouch 100. An example of a method of forming a crease in a wall to facilitate opening the pouch is disclosed in commonly assigned U.S. patent application Ser. No. 10/310,221, which is incorporated herein by reference. It should be appreciated that the shape of the finished pouch is non-limiting, and may be round, square, oval, triangular or the like. In still another example of a finishing operation, the sleeve 148 is applied over the individual pouch 100 and shrunk to fit using an application of heat to the pouch 100. In a further example of a finishing operation, a rib 124 may be added to the pouch. The rib may be thermoformed, and may provide the pouch 100 with shape or structure.

The methodology advances to 225, and the formed pouch 100 is removed from the form line, and is ready for filling. It should be appreciated that the fill-seal machine may be integral with the pouch forming machine, or may be a separate machine. The unfilled pouch may be loaded into a carrier and the carrier is transferred to a fill-seal machine. The unfilled pouch may be directly placed on a fill-seal line using a transfer means. An example of a transport means is disclosed in commonly assigned U.S. patent application Ser. No. 11/829,401, which is incorporated herein by reference.

It should be appreciated that a particular manufacturing station may perform one or a plurality of operations, to enhance the efficiency of the methodology and apparatus.

In block 230, the pouch is placed on a fill-seal line. For example, a line worker could pick up the pouch 100 and place it in a carrier 360 on the fill-seal line 370. In another example, a robotic transfer means 352 is used to transfer the pouch from the form line 310 to the fill-seal line 370. The robotic transfer means 352 can be a robotic device having an arm 354 and a gripping means 356 that picks up an individual pouch 100 from the form line 310 and places it in the pouch carrier 360 that moves between the fill-seal stations. Various types of pouch carriers 360 are available, such as a holder, a gripper or the like. An example of a holder is a cup-shaped member, as disclosed in commonly assigned U.S. patent application Ser. No. 10/336,601, which is incorporated herein by reference. Alternatively, the pouch 100 may be held using grippers as is known in the art. The gripper may hold the pouch 100 along the overlapping portion 154. The pouches 100 can be arranged on the carrier in a predetermined manner.

The methodology advances to block 235 and the pouch 100 is opened in an opening operation. Various techniques are conventionally known in the art for opening the pouch 100. For example, heated air, such as between 120-140° F., may be directed to between the upper edges of the elongated spout portion 122. The heated air causes the upper edges of the spout to curl over towards the lower edge 118 of the pouch 100, so that the pouch can easily be opened. It should be appreciated that the upper edges return to an upright position as the material cools. It is further appreciated that rib(s) 124 can be included within the elongated spout portion 122 in order to limit the amount of curling by the edges and thereby ensure their returning to the upright position as the material cools, the rib(s) 124 being formed by cold forming.

In another example, a guide pocket formed by the crease in the front panel 112 and back panel 114 facilitates opening of the pouch 100. After the pouch is initially opened, a nozzle may be mechanically lowered into the guide pocket to direct a stream of compressed gas into the guide pocket, to force the walls of the pouch 100 away from each other and further open the pouch. An example of a gas is carbon dioxide or nitrogen. A blowing station may include a manifold, with a hood extending over the top of the edges of the pouch as known in the art. The manifold has rows of apertures formed above the upper edges 116 of the pouch 100. The hood is placed over the pouch 100 to assist in maintaining the air pressure in the pouch 100. The supply of pressurized gas is directed through the apertures to form a plurality of jets of pressurized gas or air. The jets are directed downwardly at diamond-shaped openings formed at the upper edges 116 to assist in overcoming the surface tension of the pouch and assist in separation of the walls 112, 114. A diving rod (not shown) may then be used to make sure the pouch 100 is fully opened. In an example of a pouch that is filled through the fitment 136, the gas is injected through the fitment. After the pouch 100 is opened, it may be injected with super-saturated steam to eliminate any pathogens or the like.

In block 240, the pouch 100 is filled with the product in a filling operation. The pouch 100 may be filled through an open edge, or through the fitment, as previously described. If the pouch 100 is large, the pouch may be filled at more than one station. An example of a fill tube includes a tubular portion, and a head portion on one end of the tubular portion. In this example, the head portion is elongated in a transverse direction. A lower surface of the head portion includes a plurality of openings for directing the product therethrough. The openings may have a predetermined pattern, and each opening may have a predetermined size and shape. The configuration of the head can advantageously avoid splash of the product as the pouch 100 is filled.

In one example, a fill tube is lowered into the opened pouch 100 and the product is dispensed into the open pouch 100. The fill tube may be raised at a predetermined rate as the product is dispensed. For example, the fill tube may be raised just ahead of the filling product.

If the product is naturally carbonated, such as a sparkling wine or the like, the pouch 100 is preferably filled while immersed in a nitrogen or carbon dioxide atmosphere. If the product is not naturally carbonated and carbonation is desirable, it can be immersed in a carbonator to introduce carbon dioxide into the product. For example, carbon dioxide is introduced into cold water or juice to provide a carbonated beverage. The product may contain a mixture of up to four volumes of carbon dioxide. It should be appreciated that the carbon dioxide masks any undesirable taste from ketones and other solvents released during the sealing process. The carbon dioxide also increases the pressure within the product so that the walls of the pouch 100 are rigid after the top is sealed. The product is preferably filled at a temperature ranging from 29° F. to ambient temperature. The filled pouch can have the oxygen removed from the pouch 100 at this time also. In addition, the pouch 100 may be flushed with carbon dioxide. Any gas in the head space of the pouch is removed. For example, oxygen may be removed by applying a vacuum.

In block 245, the pouch 100 is sealed. Cool air may be directed to the upper edge of the pouch 100 to straighten or uncurl the edge. Various techniques are available for sealing the pouch 100. The seal technique depends on the product contained in the pouch 100, the pouch shape, or type of opening means or how the pouch is filled. For example, a closing seal may be a heat weld, or an ultrasonic seal or ultra pulse seal.

If the pouch 100 can be is filled through the open edges with a carbonated product, or product having an alcoholic content, the open edges of the pouch 100 can be closed by applying a first closing seal 152. The first closing seal 152 may be an ultrasonic seal, or an ultra pulse seal. An example of a closing seal for a pouch containing a carbonated beverage is described in commonly owned PCT Patent Application No. PCT/US03/034396 which is incorporated herein by reference.

In an example of an overlap seal, the closing seal 152 extends a predetermined amount over the side seal 120 along the upper edge 116. The ribs 124 in the neck portion of the elongated spout portion 122 add rigidity to the material 304, so that the outermost edges of each panel in the neck portion remain in contact, and do not curl, to improve the seal.

A second closing seal (not shown) may be applied a predetermined distance apart from the first seal 152. The second seal may be a heat weld or a cosmetic seal or an ultrasonic seal or the like. For a carbonated product, the location of the second seal is selected so that some of the product is trapped between the first seal 152 and the second seal. This is advantageous since it eliminates the potential for gas in the head space, i.e. the region between the product and the heat seal. The second seal is spaced outboard or outwardly of the first seal 152. Another advantage of the location of the second seal is that the overall length of the pouch may be reduced, resulting in less pouch material. In a further example, the first closing seal 152 is a tack seal, and the second closing seal is a high pressure, high temperature seal. A cosmetic seal may applied with respect to the first and second closing seals, or the second seal may be a cosmetic seal.

In yet another example, the pouch 100 is filled through the threaded fitment 136 (FIG. 6) and the cap 134 is applied to close the pouch 100. The cap 134 contains the product within the filled pouch and prevents leakage of the product from the pouch 100. The cap 134 may be a tamper-evident cap for a carbonated product. For a carbonated product, the complementary arrangement of threads and grooves in the cap and spout provides for the controlled release of pressure from the pouch, as disclosed in commonly assigned U.S. patent application Ser. No. 11/195,906, which is incorporated herein by reference.

The methodology advances to block 250 and the pouch 100 is finished in a finishing operation. For example, the edges of the pouch 100 may be trimmed to achieve a predetermined shape. In addition, the pouch 100 may be cooled at a cooling station, where the pouch 100 is cooled using a conventionally known cooling technique. Optionally, the sleeve 148 may be placed over the filled pouch and shrunk to fit over the pouch 100 by applying heat. The sleeve 148 forms an outer layer of the pouch. The methodology advances to block 255.

In block 255 the filled pouch 100 is discharged from the machine. A plurality of pouches 100 may be placed in a package for sales or shipping purposes.

It should be appreciated that the pouch 100 may undergo other processing steps, such as an upstream oxygen purging station, downstream oxygen purging station, pasteurization or the like. For example, the filled pouch 100 may be pasteurized in an integral retort chamber (not shown) that heats and then cools the pouch 100. The pouch 100 may be tested, such as burst testing or the like prior to packaging for shipping. These additional processing steps may take place at a station on the form/fill/seal apparatus, or on another apparatus.

It should be appreciated that the order of steps may vary depending on the pouch 100 and its features. Also, a particular manufacturing station may perform one or a plurality of operations, to enhance the efficiency of the methodology and apparatus.

Referring to FIG. 10, the machine 300 for carrying out the method described with respect to FIG. 9 is illustrated. Various styles of machines 300 are contemplated for forming or filling and sealing the pouch 100, such as a flat bed, conveyor or the like. An example of such a machine is manufactured by Nishibe, such as the model number SBM500, SMB600 or SMB700. The machine may include a form line 310 and/or a fill line 370. The machine includes a base and a transport means, such as a conveyor, that transports the material through the various stations. The roll of material 304 is mounted along a horizontally oriented axis, and is unrolled along a material feed station.

The unrolling material 304 passes through an alignment station 318. At the alignment station 318, material rolls pass through an optical reader. As previously described, the optical reader reads a predefined point with respect to the material. This predefined point may be a registration mark on the material, or the edge of the material.

The machine 300 can utilize the registration marks to automatically adjust the orientation of the unrolling material 304 position along an axis. For example, rollers 320 are used to adjust the position of the unrolling material 304 ±2 degrees relative to a vertically oriented center axis.

The machine includes a cutting station 324 where the aligned material is cut into a predetermined number of sections. For a pouch 100 made from two panels of material, one of the sections is rotated 180 degrees, and the first and second sections of this example are positioned such that inner sides face one another. The sections are used to form the front panel 112 and back panel 114 of the pouch 100, respectively.

It should be appreciated that a feature, as previously described, may be added between the facing sheets at an appropriate station, such as the insert station. The facing sections are transferred along the conveyer to a sealing station 328. The sealing station 328, as previously described, forms the seams joining the facing sections of material and delineating each pouch. In this example, the side edges 120 of each of the pouches 10 along the width of material 304 are heat-sealed in this operation. Because of the precise alignment of the material sheets, the width of the side edge seam 121 may be reduced, such as 4 mm, with a tolerance of ±1 mm. The ribs 124 may also be added at the sealing station.

The material 304 is moved along a conveyer 212 to a cutting station 330 and the material is cut into individual pouches. For example, the pouch 100 is cut along the side seam 121. The pouch 100 is then cut along the upper edge 116 and lower edge 118. The cut may be a double cut, so as to separate two pouches at one time.

The conveyer 212 then transfers the individual pouches to an unloading station 332, wherein the individual pouches are taken off the conveyor and placed into a receptacle, such as a holder 360, a magazine or the like. It should be appreciated that the pouches 10 can be fully formed, except for that the upper edges 116 of the panels 112, 114 are unsealed.

The pouches are now ready for filling. It should be appreciated that the pouches may be filled and sealed on another machine, or at fill-seal stations associated with the above described machine 300. In addition, the line speed between the form line 310 and the fill line 370 can be coordinated, and such coordination may increase the overall pouch production rate. Illustrative examples are a form line rate of generally 800 pouches per minute and a fill line rate of generally 300 pouches per minute.

The fill-seal line 370 can include the pouch carrier 360 that simultaneously moves a plurality of pouches, arranged in a predetermined manner, such as transversely in a row, through each of the stations in the fill-seal line. The pouch carrier 360 is operatively connected to a conveyor 372. In an example, the conveyer 372 may be chain driven for continuous motion. For example, eight pouches can be arranged transversely are filled and sealed at a time to improve the efficiency of the machine 300.

Stations 376 of the form-fill line 370 of the machine 300 may be arranged in a linear manner, such as on a linear transport table. Further the pouches may be arranged in a circular manner, such as on a rotational transport table as shown in FIG. 10. The stations 376 may be further arranged transversely or vertically.

The fill seal line 370 of the machine 300 includes an opening station 378, in order to separate the upper edges of the pouch. Various techniques are conventionally known in the art for further opening the pouch 100. For example, suction cups or grippers or the like may be utilized to open the pouches. A stream of heated air may be directed toward the upper edges of the pouch, causing the upper edges to curl. In addition, a nozzle may be mechanically lowered into the pouch to direct a stream of compressed gas downwardly into the pouch to force the walls of the pouch away from each other to further the pouch. An example of a gas is carbon dioxide or nitrogen.

In addition, the opening station 378 may include a manifold, with a hood extending over the top of the edges of the pouch. The manifold has rows of apertures (not shown) formed above the upper edges 116 of the walls of the pouch 100. The hood is placed over the pouch 100 to assist in maintaining the air pressure in the pouch. The supply of pressurized gas is directed through the aperture to form a plurality of jets of pressurized gas or air. The jets are directed downwardly at the diamond-shaped openings formed at the upper edges 116 to assist in overcoming the surface tension of the walls and assist in separation of the walls. A diving rod (not shown) may then be used to make sure the pouch 100 is fully opened. Steam or another type of sterilizer may be utilized to clean an inside wall of the opened pouch 100.

The opened pouch 100 can move to a filling station 380, and the pouch filled with the product. For example, a nozzle 381 dispenses a predetermined amount of product into the opened pouch 100. The product may be dispensed into the opened edges 116 of the pouch 100 or through a fitment. In this example, the fill nozzle 381 is lowered into the opened pouch 100, and the product is dispensed into the open pouch. The nozzle 381 can be raised at a predetermined rate corresponding to the rate of filling the pouch 100, to keep the product in the pouch and avoid overspray. Depending on the size of the pouch 100, there may be additional fill nozzles.

If the product is naturally carbonated, such as beer or soda or the like, the pouch 100 is preferably filled while immersed in a nitrogen atmosphere. If the product is not naturally carbonated, it is immersed in a carbonator to introduce carbon dioxide into the product. For example, carbon dioxide is introduced into cold water or juice to provide a carbonated beverage. The product may contain a mixture of up to four volumes of carbon dioxide. It should be appreciated that the carbon dioxide masks any undesirable taste from ketones and other solvents released during the sealing process. The carbon dioxide also increases the pressure within the product so that the walls of the pouch 100 are rigid after the top is sealed. The product is preferably filled at a temperature ranging from 29° F. to ambient temperature. The carbonation is advantageous as a microbiocide which can enhance the flavor or prevent mold or contamination.

The pouch 100 may move to a gas removal station for removing any oxygen from the pouch. Various techniques are known in the art for removing the gas. This can be done by providing a hood or diving nozzle where oxygen is either evacuated or replaced with carbon dioxide or nitrogen into the pouch to displace the oxygen. A diving nozzle is used to inject the gas or liquid nitrogen.

The pouch 100 can then be transferred to a sealing station 382 and if filled through the open edges of the pouch, the open edges of the pouch are sealed using a closing seal. As the heated upper edges 123 of the elongated spout portion 122 cools, the edges 123 return to an upright position. The ribs 124 insure that the edges 123 of the front and back panel 112, 114 are adjacent each other. The closing seal 152 may be a thermal seal.

Another example of a closing seal 152 for a product utilizes an ultrasonic sealing process. The ultrasonic seal may include sound waves and is formed using a horn and anvil. A second seal, if utilized, is applied at a second sealing station 384. The second seal may be applied using a heat seal to form a second heat seal spaced apart a predetermined distance from the first closing seal 152. It should be appreciated that the second seal may be spaced slightly outwardly of the first seal 152. The second heat-sealing station is conventional and utilizes heat or a combination of heat and pressure to form the seal. The second seal may also be a cosmetic seal or another type of seal, such as ultrasonic, ultra pulse or the like. The first and second seals are applied for a carbonated product as disclosed in commonly assigned Patent Application No. PCT/US03/34396, which is incorporated herein by reference.

If the pouch 100 is filled through the threaded fitment 136, the pouch can be closed by securing the cap 134 to the fitment. The cap 134 may have a tamper-evident feature. In addition, the cap 134 may contain the tracking device 138.

The pouch 100 can be transferred to a finishing station 386 for finishing and removal from the filling machine. For example, the hanging aperture 146 may be formed at this time. Similarly, the tear notch 132 may be formed in the pouch 100 to facilitate opening the pouch to access the product therewithin. In another example of a finishing operation, the edges of the pouch 100 are trimmed to achieve a desired shape.

The machine may include a removal station 388 for removing the pouches 100 from the machine. A gripper may be utilized to transfer the pouches. The grippers grab the pouch and lift the pouch from the pouch carrier 360. The carriers 360 may then be moved by the conveyor through a rinsing station and/or returned to the other side of the machine for reuse.

The finished pouches 10 may be transferred to a packaging machine. For example, grippers may be utilized to move the finished pouches. In an example, the packaging machine may be integral with the form-fill-seal machine or a separate line.

It should be appreciated that the automated machine 300 may include other operations. For example, the filled pouch may be transferred to another conveyor belt, or otherwise collected. Alternatively, other stations may include a straw pierceable opening station, an upstream oxygen purging station, downstream oxygen purging station, or the like.

If desired, the pouch 100 may be transferred to a pasteurization station. Pasteurization enhances the shelf life of the product. The pouch 100 is inserted into an enclosed chamber and, for example, a combination of steam and water is used to heat the pouch to a predetermined temperature for a predetermined period of time to pasteurize the product contained within the pouch. The package is then cooled, for example by recirculating water around the pouch. In certain instances, it may be desirable to apply steam to sterilize the pouch 100 and to wet the inner surface of the walls to facilitate handling.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced other than as specifically described.

1. A flexible container for packaging a product, said container comprising:
a flexible pouch having an elongated spout portion extending therefrom; and
an opening element located at least partially within said elongated spout portion, said opening element operable to create an opening across said elongated spout portion so that a product contained in said flexible pouch can be removed.

2. The flexible container of claim 1, wherein said elongated spout portion has the shape of a bottle cap portion attached to a top of a bottle throat portion.

3. The flexible container of claim 1, wherein said opening element is a notch located at least partially within said elongated spout portion.

4. The flexible container of claim 3, wherein said elongated spout portion has a pair of side edges extending from said flexible pouch.

5. The flexible container of claim 4, wherein said notch is located in at least one of said pair of side edges.

6. The flexible container of claim 1, wherein said flexible pouch has a front panel and a back panel, said front panel and said back panel each having an upper edge and a pair of side edges extending from said upper edge, said elongated spout portion extending from said upper edge in a direction generally away from said pair of side edges.

7. The flexible container of claim 6, wherein a side seam joins one of said pair of side edges of said front panel to one of said pair of side edges of said back panel, said side seam extending to and joining a predetermined distance of said upper edge of said front panel to said upper edge of said back panel.

8. The flexible container of claim 7, wherein a closing seam overlaps said side seam and joins at least part of said upper edge and at least part of said elongated spout portion of said front panel to at least part of said upper edge and at least part of said elongated spout portion of said back panel.

9. A flexible pouch for packaging a product, said pouch comprising:
a front panel and a back panel, said front panel and said back panel each having an inner surface, an upper edge, a pair of side edges extending from said upper edge and an elongated spout portion extending from said upper edge in a direction generally away from said pair of side edges;
a side seam joining one of said pair of side edges of said front panel to one of said pair of side edges of said back panel, said side seam extending to and joining a predetermined distance of said upper edge of said front panel to said upper edge of said back panel;
a closing seam overlapping said side seam and joining at least part of said upper edge of said front panel to said upper edge of said back panel, said closing seam also joining at least part of said elongated spout portion of said front panel to at least part of said elongated spout portion of said back panel;
an opening element located at least partially within said elongated spout portion of said front and back panels.

10. The flexible container of claim 9, wherein said elongated spout portion has a top edge.

11. The flexible pouch of claim 10, wherein said closing seam joins at least part of said elongated spout portion of said front panel to at least part of said elongated spout portion of said back panel along said top edge.

12. The flexible pouch of claim 9, wherein said opening element is a notch located at least partially within said elongated spout portion, for the purpose of providing a tear-off top.

13. The flexible pouch of claim 12, wherein said notch is spaced apart from said top edge.

14. The flexible pouch of claim 12, wherein said notch is spaced apart from said closing seam.

15. The flexible pouch of claim 9, further comprising an aperture located at least partially within said front panel and said back panel, said aperture operable to hang the flexible pouch from a member extending through said aperture.

16. The flexible pouch of claim 15, wherein said aperture is located at least partially within said elongated spout portion.

17. The flexible pouch of claim 15, wherein said aperture is located at least partially within said side seam.

18. A process of making a flexible pouch containing a product, the method comprising:
providing a roll of flexible material;
unrolling the flexible material from the roll;
cutting a section from the flexible material, the section having a front panel and a back panel, each panel having an inner surface, an upper edge, a pair of side edges extending from said upper edge and an elongated spout portion extending from said upper edge in a direction generally away from said pair of side edges;
arranging the front panel and the back panel such that the inner surface of the front panel is facing the inner surface of the back panel;
forming a pair of side seams by joining the pair of side edges of the front panel to the pair side edges of the back panel, the side seams extending to and joining a predetermined distance of the upper edge of the front panel to the upper edge of the back panel, the side seam also leaving an opening between the upper edge and the elongated spout portion of the front panel and the upper edge and the elongated spout portion of the back panel;
blowing hot air onto the elongated spout portion of the front panel and the elongated spout portion of the back panel, the blowing of hot air curling a top edge of at least one of the elongated spout portions;
inserting a tube within the opening;
passing a product through the tube into a container formed by the front panel and the back panel;
removing the tube from the container;
sealing the container by joining at least part of said upper edge and at least part of said elongated spout portion of said front panel to at least part of said upper edge and at least part of said elongated spout portion of said back panel; and
forming an opening element for opening the container and allowing access to the product contained in the flexible pouch.

19. The process of forming a flexible pouch of claim 18, wherein the opening element is a notch cut into the elongated spout, the notch operable to create a tear across said elongated spout and allow the product to exit the flexible pouch.

20. The process of forming a flexible pouch of claim 19, wherein the elongated spout portion has a bottle cap shaped portion extending from a bottle top shaped portion.

21. The process of forming a flexible pouch of claim 20, wherein the notch is located within the bottle top shaped portion and is spaced apart from the bottle cap shaped portion of the elongated spout portion.
